(19) United States
(12) Patent Application Publication
(10) Pub. No.: US 2017/0163914 A1
(43) Pub. Date: Jun. 8, 2017

(54) SOLID-STATE IMAGING DEVICE AND CAMERA

(71) Applicant: Panasonic Intellectual Property Management Co., Ltd., Osaka (JP)

(72) Inventor: Kunihiko HARA, Osaka (JP)

(21) Appl. No.: 15/436,034

(22) Filed: Feb. 17, 2017

Related U.S. Application Data
(63) Continuation of application No. PCT/JP2015/003151, filed on Jun. 24, 2015.

(30) Foreign Application Priority Data
Aug. 20, 2014 (JP) 2014-167975

(51) Int. Cl. H04N 5/353; H04N 5/357; H04N 5/365; H04N 5/33; H04N 5/378

(52) U.S. Cl. CPC H04N 5/3537; H04N 5/332; H04N 5/378; H04N 5/365; H04N 5/3575

(57) ABSTRACT

A solid-state imaging device includes: an imager that includes a plurality of pixels; a row selection circuit that controls a charge accumulation period and that selects pixels from the plurality of pixels on a row-by-row basis; and a read circuit that reads signals held in the pixels selected by the row selection circuit, wherein each of the plurality of pixels included in the imager is classified into one of a plurality of types of pixels that receive light with different characteristics, and for pixels disposed in the same row of the imager, the row selection circuit controls the charge accumulation period so that the charge accumulation period for a first type out of the plurality of types of pixels (G pixel, R pixel, B pixel) is a first charge accumulation period, and the charge accumulation period for a second type of pixels (IR pixel) is a second charge accumulation period.

### CROSS REFERENCE TO RELATED APPLICATIONS

This application is a U.S. continuation application of PCT International Patent Application Number PCT/JP2015/003151 filed on Jun. 24, 2015, claiming the benefit of priority of Japanese Patent Application Number 2014-167975 filed on Aug. 20, 2014, the entire contents of which are hereby incorporated by reference.

### BACKGROUND

1. Technical Field

The present disclosure relates to a solid-state imaging device including pixels for receiving light disposed in rows and columns, and a camera including the solid-state imaging device.

2. Description of the Related Art

In recent years, various solid-state imaging devices have been proposed to achieve improvement in the image quality of a digital camera or a mobile phone (for instance, see Japanese Unexamined Patent Application Publication No. 2005-6066).

In the solid-state imaging device of Japanese Unexamined Patent Application Publication No. 2005-6066, the G filter of one of RGBG pixels included in one unit of a Bayer array is replaced by an infrared (IR) filter, and signal processing is performed by using the RGB filters for a first mode and the IR filter for a second mode separately, thereby achieving both color reproducibility during daytime and improvement in sensitivity at night.

### SUMMARY

However, with the aforementioned conventional technique, a problem arises in that due to imperfection of the optical characteristics of filters, mixing of unnecessary components of light into pixels occurs, and a high image quality is not obtained. Specifically, with the aforementioned conventional technique, transmittance characteristics of each color filter are not perfect, and thus there is a problem of mixed color in each pixel. For instance, when a light source having both components of visible light and IR is photographed, not only light of each color component, but also light of IR component enters R pixels, G pixels, and B pixels to some extent. In addition, not only light of IR component, but also light of R component and other is mixed into IR pixels to some extent. In order to correct such mixture of colors, for instance, in a digital camera, correction processing based on software is performed using a digital value indicating each color component obtained by a solid-state imaging device. However, such post-processing has a limitation of improvement in the image quality.

It is to be noted that when pixels are used as a sensor for ranging, the problem of color mixture causes deterioration of the accuracy of the ranging, and when pixels are used as a sensor for qualitative or quantitative analysis of a sample, the problem of color mixture causes deterioration of the accuracy of the analysis. Thus, in the aforementioned conventional technique, there is a problem in that the accuracy of signal processing deteriorates by mixture of colors.

Thus, the present disclosure has been made in view of the above-mentioned problems, and it is an object of the disclosure to provide a solid-state imaging device and a camera including the solid-state imaging device capable of reducing deterioration of the accuracy of signal processing, the deterioration being caused by mixing of unnecessary components of light into each of a plurality of types of pixels.

In order to achieve the aforementioned object, a solid-state imaging device according to an aspect of the present disclosure includes: an imager that includes a plurality of pixels which are disposed in rows and columns and each of which holds a signal corresponding to a charge accumulated according to an amount of light received in a charge accumulation period; a row selection circuit that controls the charge accumulation period and selects pixels from the plurality of pixels on a row-by-row basis; and a read circuit that reads and outputs signals held in the pixels selected by the row selection circuit, wherein each of the plurality of pixels included in the imager is classified into one of a plurality of types of pixels that receive light with different characteristics, and for pixels disposed in the same row of the imager, the row selection circuit controls the charge accumulation period so that a charge accumulation period for a first type out of the plurality of types of pixels is a first charge accumulation period, and a charge accumulation period for a second type different from the first type out of the plurality of types of pixels is a second charge accumulation period different from the first charge accumulation period.

Thus, even for pixels in the same row, an independent charge accumulation period can be provided according to the type of each of the pixels, and therefore, a charge accumulation period is provided with an optimal timing or length according to the type of each pixel, and thus the accuracy of signal processing is improved. For instance, in each pixel, charge can be accumulated at the timing of incidence of the light exactly from a light source corresponding to the type of each pixel, and deterioration of accuracy (such as image quality, accuracy of ranging, or analysis accuracy) of signal processing is reduced.

Here, the first type of pixels may be pixels that receive light in a first wavelength range, and the second type of pixels may be pixels that receive light in a second wavelength range different from the first wavelength range.

Thus, a charge accumulation period for pixels for each color component is set according to the type of each of light sources with different wavelengths, in synchronization with the timing of light emission, and thus mixture of colors in pixels is reduced. For instance, charge accumulation periods can be provided so that in a light emission period for IR light, only the pixels for IR light accumulate charge, and the pixels for visible light do not accumulate charge. Thus, mixture of colors in pixels is reduced and deterioration of the accuracy (such as an image quality) of signal processing is reduced.

Also, the first wavelength range may be a wavelength range of visible light, and the second wavelength range may be a wavelength range of infrared light or ultraviolet light.

Thus, mixture of colors in pixels for visible light and pixels for infrared light or mixture of colors in pixels for visible light and pixels for ultraviolet light is reduced, and deterioration of image quality is reduced.

Also, the first type of pixels may be pixels that receive light in a first direction, and the second type of pixels may be pixels that receive light in a second direction different from the first direction.

Thus, an independent charge accumulation period can be provided according to the type of each of light sources with different directions for receiving light, and a charge accumulation period is provided with an optimal timing or length according to the type of each pixel, and thus deterioration of the accuracy (accuracy of ranging using signals by light in two directions) of signal processing is reduced.

Also, the light in the first direction is light that is incident on all of light receiving areas included in the first type of pixels, and the light in the second direction is light that is incident on part of the light receiving areas included in the second type of pixels. In this case, the first charge accumulation period and the second charge accumulation period may be different in length.

Thus, in each pixel, charge is accumulated only during a period having a length according to the intensity of light incident on the pixel. For instance, the charge accumulation period for the second type of pixels in which light is incident on part of light receiving areas can be set to be longer than the charge accumulation period for the first type of pixels in which light is incident on all of the light receiving areas. Therefore, in the second type of pixels that receive light having a low intensity, deterioration of the accuracy of signal processing due to shortage of light quantity is reduced.

Also, the first charge accumulation period and the second charge accumulation period may be partially overlapped.

Also, after reading the signals from all of the first type of pixels included in the imager, the read circuit reads the signals from all of the second type of pixels included in the imager.

Thus, even when reading methods (circuit operation) are different for the first type of pixels and the second type of pixels, the reading method does not need to be switched until reading from all the pixels of the same type is completed. Consequently, the frequency of switching between reading methods is decreased, and unstable operation of the circuit is avoided.

Also, the read circuit may amplify the signals read from the first type of pixels by a first magnification, and may amplify the signals read from the second type of pixels by a second magnification different from the first magnification.

Thus, the magnification of amplification does not have to be changed until reading signals from all the pixels of the same type is completed, and therefore, the frequency of switching between magnifications of amplification is decreased, and unstable operation of the circuit is avoided.

It is to be noted that the read circuit may read the signals held in the pixels selected by the row selection circuit, via a column signal line, and the first type of pixels and the second type of pixels may share a circuit that outputs the signals held in the first type of pixels and the second type of pixels to the column signal line.

Also, the first type of pixels may be pixels that have a first optical input structure, and the second type of pixels may be pixels that have a second optical input structure different from the first optical input structure.

Also, the first type of pixels may be pixels that have a first optical input structure, the second type of pixels may be pixels that have a second optical input structure different from the first optical input structure, and at least one of the first optical input structure and the second optical input structure may include a light blocker.

In order to achieve the aforementioned object, a camera according to an aspect of the present disclosure includes one of the above-described solid-state imaging devices.

Thus, even for pixels in the same row, an independent charge accumulation period can be provided according to the type of each of the pixels, and therefore, a charge accumulation period is provided with an optimal timing or length according to the type of each pixel, and thus deterioration of accuracy (such as image quality, accuracy of ranging, or analysis accuracy) of signal processing is reduced.

With the solid-state imaging device and camera according to an aspect of the present disclosure, deterioration of the accuracy of signal processing is reduced, the deterioration being caused by mixing of unnecessary components of light into each of a plurality of types of pixels.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a circuit diagram of a solid-state imaging device in embodiment 1 of the present disclosure;

FIG. 2 is a detailed circuit diagram of an imager and a read circuit (a pixel current source, a clamp circuit, and S/H circuit) illustrated in FIG. 1;

FIG. 3 is a detailed circuit diagram of column ADC included in the read circuit illustrated in FIG. 1;

FIG. 4 is a timing chart illustrating the primary operation of the solid-state imaging device illustrated in FIG. 1;

FIG. 5 is a diagram illustrating the timing of charge accumulation of the solid-state imaging device illustrated in FIG. 1;

FIG. 6 is a circuit diagram of a solid-state imaging device in Embodiment 2 of the present disclosure;

FIG. 7 is a sectional view illustrating the structure of the pixels included in the imager illustrated in FIG. 6 and a diagram illustrating a relationship between the horizontal direction and the sensitivity of the pixels;

FIG. 8 is a diagram illustrating the timing of charge accumulation of the solid-state imaging device illustrated in FIG. 6;

FIG. 9 is a graph illustrating a relationship between the difference of intensities of incident light on GL pixel and GR pixel and the distance to an object;

FIG. 10 is an external view of a camera in Embodiment 3 of the present disclosure; and

FIG. 11 is a block diagram illustrating an example of the configuration of the camera illustrated in FIG. 10.

### DETAILED DESCRIPTION OF THE EMBODIMENTS

Hereinafter, a solid-state imaging device and a camera according to an aspect of the present disclosure will be specifically described with reference to the drawings.

It is to be noted that each of the embodiments described below illustrates a specific example of the present disclosure. The numerical values, materials, structural components, the arrangement positions and connection configurations of the structural components, operation timings shown in the following embodiment are mere examples, and are not intended to limit the scope of the present disclosure. Also, among the structural components in the following embodiments, components not recited in any one of the independent claims which indicate the most generic concepts are described as arbitrary structural components.

### Embodiment 1

First, a solid-state imaging device in embodiment 1 of the present disclosure will be described.

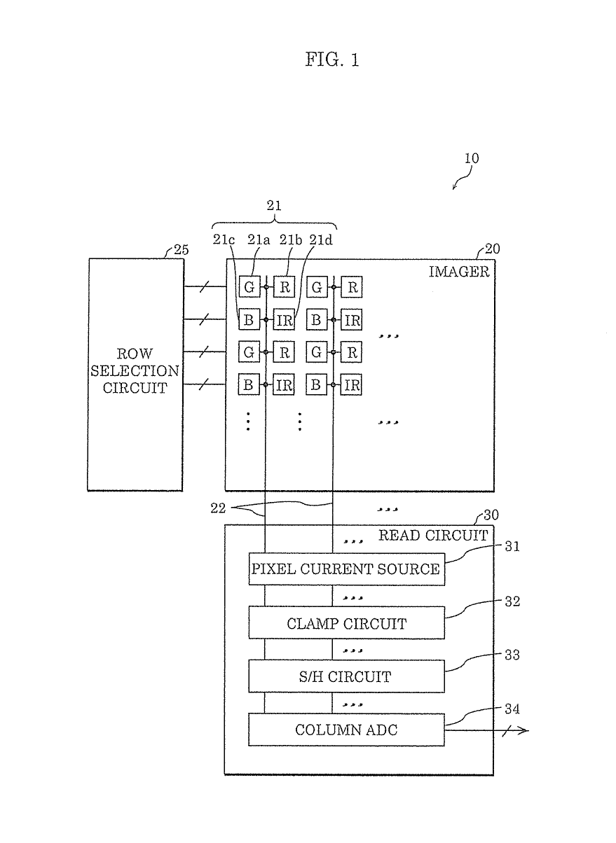

FIG. 1 is a circuit diagram of solid-state imaging device 10 in embodiment 1 of the present disclosure. Solid-state imaging device 10 is an image sensor (CMOS image sensor in this embodiment) that outputs an electrical signal according to an amount of light received from an object, and includes imager 20, row selection circuit 25, and read circuit 30. In this embodiment, solid-state imaging device 10 is an image sensor that can capture a visible light image and an infrared light image (including a near-infrared light image) at the same time.

Imager 20 is a circuit that includes a plurality of pixels 21 which are disposed in rows and columns, and each of which holds a signal corresponding to a charge accumulated according to an amount of light received during a charge accumulation period. Each of a plurality of pixels 21 included in imager 20 is classified into one of a plurality of types of pixels (G pixel 21a, R pixel 21b, B pixel 21c, IR pixel 21d in this embodiment) that receive light with different characteristics. It is to be noted that G pixel 21a, R pixel 21b, B pixel 21c and IR pixel 21d respectively have G (green) filter, R (red) filter, B (blue) filter and IR (infrared) filter, and are disposed in an array in which one G pixel is replaced by IR pixel in a Bayer array as illustrated in FIG. 1. IR filter may be produced by stacking R filter and B filter, for instance. Since each of R filter and B filter has characteristics to allow IR component to pass through, the light which passes through both R filter and B filter is mainly the light of IR component.

Also, in imager 20 in this embodiment, one column signal line 22 is disposed for pixels 21 in two columns in the column direction. In other words, imager 20 has so-called a horizontal two-pixel one-cell structure in which one cell is formed by two pixels located on the right and left of column signal line 22 (that is, one amplification transistor is provided for every two light receiving elements side-by-side in the row direction).

Row selection circuit 25 is a circuit that controls the charge accumulation period in imager 20 and that selects pixels 21 from a plurality of pixels 21 included in imager 20 on a row-by-row basis. As control of the charge accumulation period in imager 20, row selection circuit 25 controls the charge accumulation period by an electronic shutter so that for the pixel disposed in the same row of imager 20, a charge accumulation period for a first type out of a plurality of types of pixels is a first charge accumulation period, and a charge accumulation period for a second type different from the first type out of the plurality of types of pixels is a second charge accumulation period different from the first charge accumulation period. The first type of pixels are pixels that receive light in a first wavelength range (here, a wavelength range of visible light), and are G pixel 21a, R pixel 21b, and B pixel 21c in this embodiment. Also, the second type of pixels are pixels that receive light in a second wavelength range (here, infrared light) different from the first wavelength range, and is IR pixel in this embodiment.

Read circuit 30 is a circuit that reads and outputs a signal (pixel signal) held in pixel 21 from pixel 21 selected by row selection circuit 25, and has pixel current source 31, clamp circuit 32, S/H (sample hold) circuit 33, and column ADC 34. Pixel current source 31 is a circuit that supplies a current to column signal line 22, the current for reading a signal from pixel 21 via column signal line 22. Clamp circuit 32 is a circuit for removing fixed pattern noise which occurs in pixel 21 by correlation double sampling. S/H circuit 33 is a circuit that holds a pixel signal outputted to column signal line 22 from pixel 21. Column ADC 34 is a circuit that converts a pixel signal sample-held by S/H circuit 33 to a digital signal.

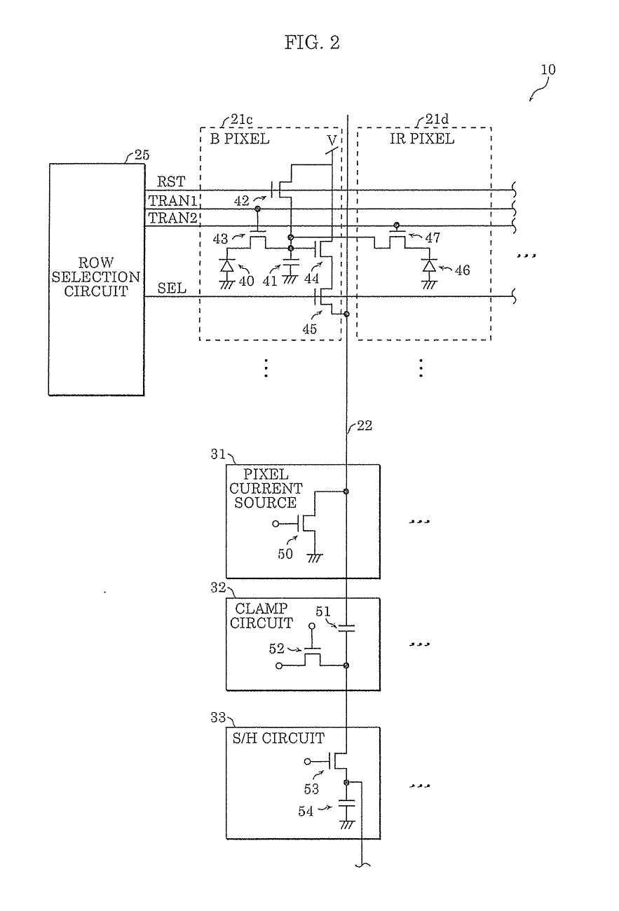

FIG. 2 is a detailed circuit diagram of imager 20, and pixel current source 31, clamp circuit 32 and S/H circuit 33 in read circuit 30. It is to be noted that FIG. 2 illustrates only the circuits related to one column signal line 22. Also, only the pixels in even-numbered rows in imager 20 are illustrated.

B pixel 21c includes photo diode PD (light receiving element) 40, floating diffusion (FD) 41, reset transistor 42, transfer transistor 43, amplification transistor 44 and row selection transistor 45. PD 40 is an element that performs photoelectric conversion on received light, and generates a charge according to an amount of light received by B pixel 21c. FD 41 is a capacitor that holds a charge generated in PD 40 and 46. Reset transistor 42 is a switch transistor used to apply a voltage for resetting PD 40 and 46 and FD 41. Transfer transistor 43 is a switch transistor for transferring a charge accumulated in PD 40 to FD 41. Amplification transistor 44 is a transistor that amplifies a voltage in FD 41. Row selection transistor 45 is a switch transistor that connects amplification transistor 44 to column signal line 22, thereby outputting pixel signal from B pixel 21c to column signal line 22.

On the other hand, IR pixel 21d includes PD 46 and transfer transistor 47. PD 46 is an element that performs photoelectric conversion on received near-infrared light, and generates a charge according to an amount of light received by IR pixel 21d. Transfer transistor 47 is a switch transistor for transferring a charge accumulated in PD 46 to FD 41.

Row selection circuit 25 outputs reset signal RST, odd numbered column transfer signal TRAN1, even numbered column transfer signal TRAN2, and row selection signal SEL as control signals for each row of imager 20. Reset signal RST is supplied to the gate of reset transistor 42, odd-numbered column transfer signal TRAN1 is supplied to the gate of transfer transistor 43 of B pixel 21c, even-numbered column transfer signal TRAN2 is supplied to the gate of transfer transistor 47 of IR pixel 21d, and row selection signal SEL is supplied to the gate of row selection transistor 45.

It is to be noted that although FIG. 2 illustrates only B pixel 21c and IR pixel 21d disposed in even-numbered rows as pixel 21, G pixel 21a and R pixel 21b disposed in odd-numbered rows also have the same configuration as that of B pixel 21c and IR pixel 21d, respectively.

For each column signal line 22, pixel current source 31 includes current source transistor 50 connected to column signal line 22. Current source transistor 50, when reading a pixel signal from pixel 21, supplies a constant current to pixel 21 selected by row selection signal SEL, thereby enabling to read from the selected pixel 21 to column signal line 22.

For each column signal line 22, clamp circuit 32 includes clamp capacitor 51 having one end connected to column signal line 22, and clamp transistor 52 connected to the other end of clamp capacitor 51. Clamp circuit 32 is provided for determining (correlation double sampling) a pixel signal when reading from pixel 21 is performed, the pixel signal being the difference between the voltage (reset voltage) when FD 41 is reset and the voltage (lead voltage) after the charge accumulated in PD 40 (46) is transferred to FD 41. Thus, when a pixel signal is read from pixel 21, in order to maintain the other end of clamp capacitor 51 at a constant potential (clamp potential), clamp transistor 52 functions as a switch transistor.

For each column signal line 22, S/H circuit 33 includes sampling transistor 53 that samples the pixel signal determined by clamp circuit 32, and hold capacitor 54 that holds the sampled pixel signal.

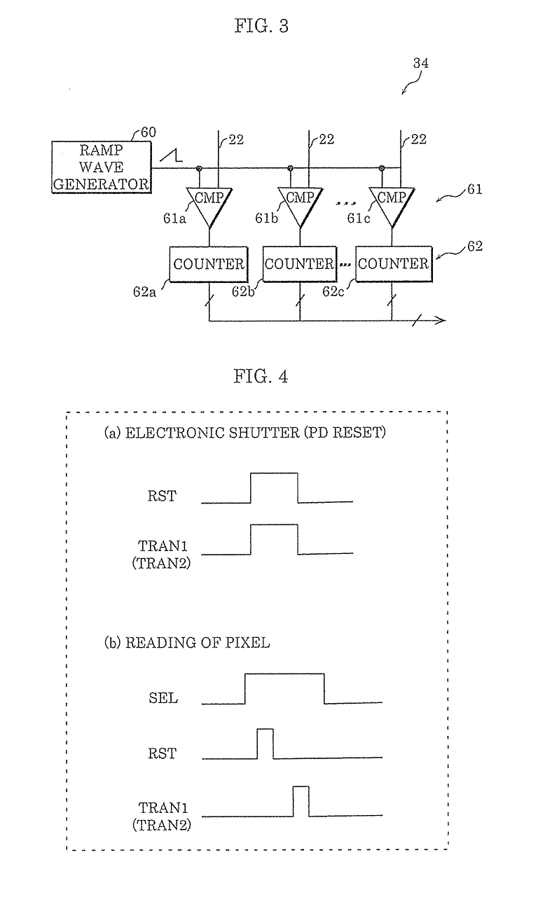

FIG. 3 is a detailed circuit diagram of column ADC 34 included in read circuit 30 illustrated in FIG. 1. Column ADC 34 is a set of A/D converters provided for each column signal line 22, and includes ramp wave generator 60, comparator 61 (61a to 61c) and counter 62 (62a to 62c) provided for each column signal line 22. Ramp wave generator 60 generates a ramp wave in which a voltage changes with a certain slope. Comparator 61 compares the voltage of a pixel signal sample-held by S/H circuit 33 with the voltage of a ramp wave generated by ramp wave generator 60, and when the voltage of the pixel signal reaches the voltage of the ramp wave, notifies counter 62 (of a comparison signal). Counter 62 receives a supply of clock signals with a constant frequency, inputted from the outside, and counts, latches, and outputs the number of clocks inputted during the time since ramp wave generator 60 started to generate a ramp wave until a comparison signal is received from comparator 61.

It is to be noted that in order to achieve a variable conversion gain in column ADC 34, ramp wave generator 60 can selectively generate any of ramp waves of at least two types of slope. In this embodiment, signals read from the first type of pixels are amplified by a first magnification, and signals read from the second type of pixels are amplified by a second magnification different from the first magnification. Specifically, for a pixel signal from G pixel 21a, R pixel 21b and B pixel 21c, ramp wave generator 60 generates a ramp wave with a gentler slope to perform A/D conversion with the first magnification (for instance, two times (×2)), whereas for a pixel signal from IR pixel 21d, ramp wave generator 60 generates a ramp wave with a steeper slope to perform A/D conversion with the second magnification (for instance, one time (×1)).

Next, the operation of thus configured solid-state imaging device 10 in this embodiment will be described.

FIG. 4 is a timing chart illustrating the primary operation of solid-state imaging device 10 in this embodiment. The operation of PD reset by an electronic shutter in imager 20 of solid-state imaging device 10 is illustrated by (a) of FIG. 4, and the read operation (reading of a pixel signal (reset voltage and lead voltage)) from a pixel in imager 20 of solid-state imaging device 10 is illustrated by (b) of FIG. 4.

As illustrated in (a) of FIG. 4, in PD reset by an electronic shutter, reset transistor 42 of target pixel 21 is temporarily turned on by reset signal RST from row selection circuit 25 and simultaneously with this, for pixel 21 in each odd-numbered row, transfer transistor 43 is also temporarily turned on by odd-numbered column transfer signal TRAN1 from row selection circuit 25 (for pixel 21 in each even-numbered row, transfer transistor 47 is temporarily turned on by even-numbered column transfer signal TRAN2 from row selection circuit 25). Thus, PD 40 (or PD 46) of pixel 21 is reset by application of a constant voltage (voltage V in FIG. 2), and immediately after this, accumulation of charge according to an amount of received light starts.

As illustrated in (b) of FIG. 4, in the read operation from a pixel while row selection transistor 45 is on by row selection signal SEL from row selection circuit 25, reset transistor 42 is temporarily turned on by reset signal RST from row selection circuit 25, then later, for pixel 21 in each odd-numbered row, transfer transistor 43 of pixel 21 is temporarily turned on by odd-numbered column transfer signal TRAN1 from row selection circuit 25 (for pixel 21 in each even-numbered row, transfer transistor 47 is temporarily turned on by even-numbered column transfer signal TRAN2 from row selection circuit 25). While reset transistor 42 is on, FD 41 is reset, and the voltage (reset voltage) of FD 41 at this point is read to column signal line 22 via amplification transistor 44 and row selection transistor 45. While transfer transistor 43 (47) is on, charge is transferred from PD 40 (or PD 46) to FD 41, and the voltage of FD 41 (lead voltage) at this point is read to column signal line 22 via amplification transistor 44 and row selection transistor 45. The difference (pixel signal) between the reset voltage and the lead voltage is determined by clamp circuit 32, and the difference (pixel signal) is converted to a digital value by column ADC 34.

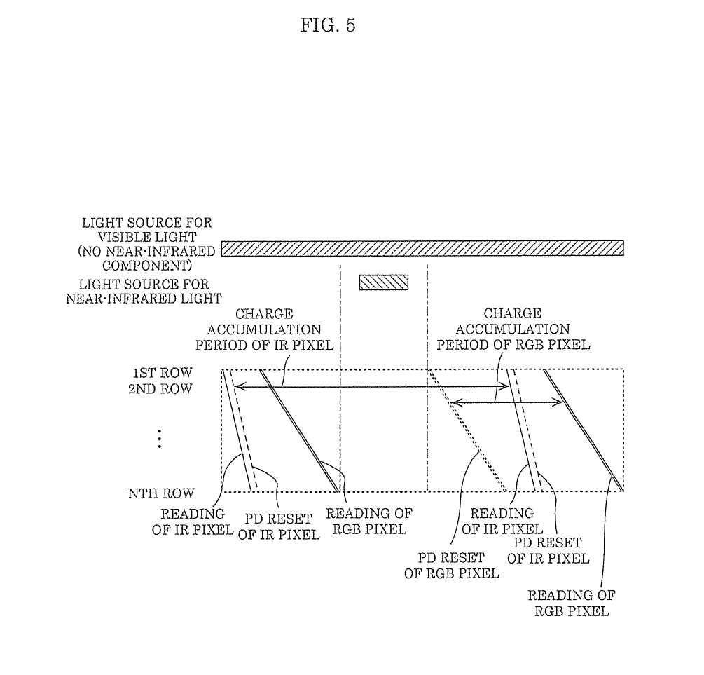

FIG. 5 is a diagram illustrating the timing of charge accumulation of solid-state imaging device 10 in this embodiment. It is to be noted that in the upper portion of FIG. 5, a light source for visible light (no near-infrared component) in an object (or toward an object) and emission timing for a light source for near-infrared light are also illustrated together. Here, for the light source for visible light, it is illustrated that visible light reflected by the object under sunlight or illumination light is incident on solid-state imaging device 10 all the time. On the other hand, for the light source for near-infrared light, it is illustrated that the light source is provided, which irradiates with near-infrared light in synchronization with the operation of solid-state imaging device 10, the object is irradiated with intense near-infrared light from the light source at the timing (in a pulsed manner) illustrated in FIG. 5, and near-infrared light reflected by the object is incident on solid-state imaging device 10. Here, “intense near-infrared light” indicates near-infrared light with intensity such that the intensity of the near-infrared light incident on solid-state imaging device 10 is extremely higher (to an extent which allows the intensity (RGB component) of the visible light incident on solid-state imaging device 10 to be negligible) than the intensity of the visible light incident on solid-state imaging device 10.

Also, in the portion of FIG. 5 illustrating the timing of charge accumulation, the vertical axis indicates the rows (1st row to nth row) of pixels 21 included in imager 20, and the horizontal axis indicates time. In addition, each single dashed line extending diagonally in the direction from the upper left to the lower right indicates the timing of PD reset (reset of PD by an electronic shutter) in IR pixel 21d, and each single solid line extending diagonally in a similar direction indicates the timing of reading (reading of a pixel signal (reset voltage and lead voltage)) from IR pixel 21d. On the other hand, each double dashed line extending diagonally in a similar direction indicates the timing of PD reset (reset of PD by an electronic shutter) in RGB pixels (R pixel 21b, G pixel 21a and B pixel 21c), and each double solid line extending diagonally in a similar direction indicates the timing of reading (reading of a pixel signal (reset voltage and lead voltage)) from RGB pixels.

It is to be noted that for the rows of imager 20 to be read from pixels, in reading from IR pixel 21d, only the pixels in even-numbered rows in imager 20 are read, and in reading from RGB pixels, the pixels of all the rows (odd-numbered rows and even-numbered rows) in imager 20 are read.

As illustrated in FIG. 5, in solid-state imaging device 10, the charge accumulation period (from PD reset of IR pixel 21d to reading) for IR pixel 21d is set to be longer than the charge accumulation period (from PD reset of RGB pixels to reading) for RGB pixels. The charge accumulation period for IR pixel 21d and the charge accumulation period for RGB pixels are set to be partially overlapped.

The period in which near-infrared light from the light source for near-infrared light is incident on solid-state imaging device 10 is the period that is in the charge accumulation period for IR pixel 21d and other than the charge accumulation period for RGB pixels. Specifically, the period is within the time interval from the completion of reading of RGB pixels until the start of PD reset of RGB pixels (the interval interposed between by two dashed dotted lines). Thus, in the charge accumulation period for IR pixel 21d, both the visible light and near-infrared light are incident on solid-state imaging device 10. However, as described above, the intensity of near-infrared light is extremely higher than the intensity of visible light, and the intensity of the visible light is negligible. Thus, a charge according to the intensity of near-infrared light is accumulated in IR pixel 21d without being affected by the visible light.

On the other hand, although the intensity of visible light is lower than that of near-infrared light, only the visible light is incident on solid-state imaging device 10 in the charge accumulation period for RGB pixels. Thus a charge according to the intensity of the visible light is accumulated in RGB pixels without being affected by the near-infrared light. In this embodiment, at the time of reading from RBG pixels with a relatively smaller amount of charge, column ADC 34 performs A/D conversion with a conversion gain (for instance, two times (×2)) higher than the conversion gain (for instance, 1 time (×1)) at the time of reading from IR pixel 21d. Therefore, in column ADC 34, a pixel signal from RGB pixels with a relatively smaller signal is amplified by a higher magnification compared with a pixel signal from IR pixel 21d.

In this manner, in solid-state imaging device 10 in this embodiment, the charge accumulation periods for the first type of pixels (RGB pixels in this embodiment) and the second type of pixels (IR pixels in this embodiment) are set independently. Thus, increased flexibility is achieved in adjusting timing for emission of a light source of a type corresponding to each of the types of pixels, and photographing with improved S/N ratio for each of the types of pixels is possible. Consequently, the S/N ratio of the pixel signal indicated by a digital signal outputted from solid-state imaging device 10 is improved, and deterioration of the accuracy (here, image quality) of signal processing is reduced.

It is to be noted that as seen from the fact that the read timing (single solid line) for IR pixel 21d in FIG. 5 and the read timing (double solid line) for RGB pixels are not overlapped, in solid-state imaging device 10 in this embodiment, after reading of IR pixels 21d for all the rows included in imager 20 is completed, reading of RBG pixels for all the rows included in imager 20 is performed. In other words, in solid-state imaging device 10, read circuit 30, after reading signals from all of the first type of pixels included in imager 20, reads signals from all of the second type of pixels included in imager 20. Thus, unstable operation of the circuit is avoided, which is due to frequent switching between conversion gains of column ADC 34.

Also, when IR filter is produced by stacking R filter and B filter, in general, such an IR filter allows components other than IR to pass through to some extent. That is, mixture of colors in IR pixel causes a problem. When it is possible to use a light source for near-infrared light, having an intensity to an extent which allows the intensity of the visible light to be negligible as in this embodiment, a mixed color component is negligible. However, when the intensity of the light source for near-infrared light cannot be increased, mixture of colors in IR pixel causes a problem. In this case, timings for emission of the two types of light sources illustrated in FIG. 5, and the charge accumulation periods for the two types of pixels may be switched.

That is, the light source for near-infrared light is set so that near-infrared light is incident on solid-state imaging device 10 all the time, and the light source for visible light is set so that visible light is incident on solid-state imaging device 10 in a pulsed manner in synchronization with the operation of solid-state imaging device 10. Consequently, in the period that is in the charge accumulation period for RGB pixels and other than the charge accumulation period for IR pixel 21d, visible light is incident on solid-state imaging device 10, and in the charge accumulation period for IR pixel 21d, only near-infrared light is incident on solid-state imaging device 10. Consequently, the intensity of only near-infrared light can be obtained by IR pixel 21d without being affected by visible light, and mixture of colors in IR pixel 21d is reduced even when intense near-infrared light is not used.

It is to be noted that although the charge accumulation periods are set at different timings between RGB pixels and IR pixel in this embodiment, without being limited to this setting, the charge accumulation period for either one of R pixel, G pixel, B pixel and IR pixel may be set at different timing depending on a photography environment or a photography target.

Although imager 20 is formed of RBG pixels and IR pixel in this embodiment, imager 20 may be formed of RBG pixels and ultraviolet (UV) pixel. In this case, instead of a light source of near-infrared light, a light source of ultraviolet light may be used. Thus, when UV pixels are used for analysis (such as an ultraviolet spectrometer) of a sample, deterioration of the accuracy of signal processing using ultraviolet light is reduced, and the accuracy of analysis is improved.

As described above, solid-state imaging device 10 in this embodiment includes: imager 20 that includes a plurality of pixels 21 which are disposed in rows and columns and each of which holds a signal corresponding to a charge accumulated according to an amount of light received in a charge accumulation period; row selection circuit 25 that controls the charge accumulation period and that selects pixels 21 from the plurality of pixels 21 on a row-by-row basis; and read circuit 30 that reads and outputs signals held in pixels 21 from pixels 21 selected by row selection circuit 25. Each of the plurality of pixels 21 included in imager 20 is classified into one of a plurality of types of pixels that receive light with different characteristics, and for the pixels disposed in the same row of imager 20, row selection circuit 25 controls the charge accumulation period so that a charge accumulation period for the first type out of the plurality of types of pixels is a first charge accumulation period, and a charge accumulation period for the second type different from the first type out of the plurality of types of pixels is a second charge accumulation period different from the first charge accumulation period.

Thus, even for pixels in the same row, an independent charge accumulation period can be provided according to the type of each of the pixels, and therefore, a charge accumulation period is provided with an optimal timing or length according to the type of each pixel, and thus the accuracy of signal processing is improved. For instance, in each pixel, charge can be accumulated at the timing of incidence of the light exactly from a light source corresponding to the type of the pixel, and deterioration of accuracy (such as image quality, accuracy of ranging, or analysis accuracy) of signal processing is reduced.

Here, the first type of pixels 21 are pixels that receive light in a first wavelength range, and the second type of pixels 21 are pixels that receive light in a second wavelength range different from the first wavelength range. Thus, a charge accumulation period for pixels for each color component is set according to the type of each of light sources with different wavelengths, in synchronization with the timing of light emission, and thus mixture of colors in pixels is reduced. For instance, charge accumulation periods can be provided so that in a light emission period for visible light, only the pixels for visible light accumulate charge, and the pixels for IR do not accumulate charge. Thus, mixture of colors in pixels is reduced and deterioration of the accuracy (such as an image quality) of signal processing is reduced.

More specifically, the first wavelength range is a wavelength range of visible light, and the second wavelength range is a wavelength range of infrared light or ultraviolet light. Thus, mixture of colors in pixels for visible light and pixels for infrared light or mixture of colors in pixels for visible light and pixels for ultraviolet light is reduced, and deterioration of image quality is reduced.

Also, read circuit 30, after reading signals from all of the first type of pixels 21 included in imager 20, reads signals from all of the second type of pixels 21 included in imager 20. Thus, even when reading methods (circuit operation) are different for the first type of pixels and the second type of pixels, the reading method does not need to be switched until reading from all of the same type of pixels is completed. Consequently, the frequency of switching between reading methods is decreased, and unstable operation of the circuit is avoided.

Also, read circuit 30 amplifies signals read from the first type of pixels 21 by a first magnification, and amplifies signals read from the second type of pixels 21 by a second magnification different from the first magnification. Thus, the magnification of amplification does not have to be changed until reading signals from all of the same type of pixels is completed, and therefore, the frequency of switching between magnifications of amplification is decreased, and unstable operation of the circuit is avoided.

### Embodiment 2

Next, a solid-state imaging device in Embodiment 2 of the present disclosure will be described.

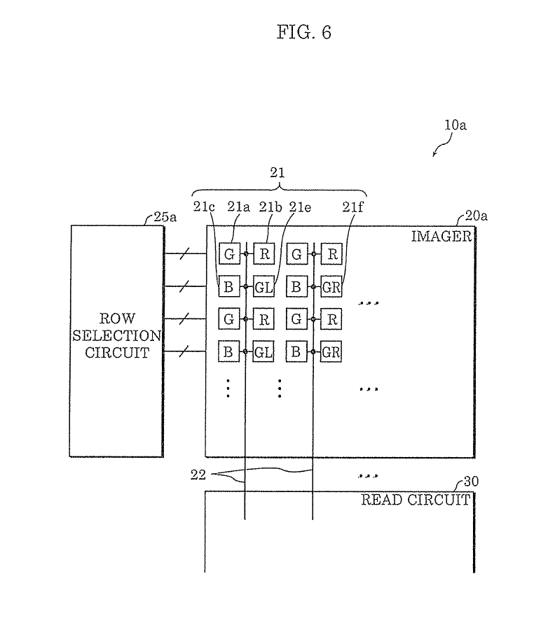

FIG. 6 is a circuit diagram of solid-state imaging device 10a in Embodiment 2 of the present disclosure. Solid-state imaging device 10a is an image sensor (CMOS image sensor in this embodiment) that outputs an electrical signal according to an amount of light received from an object, and includes imager 20a, row selection circuit 25a, and read circuit 30. In this embodiment, solid-state imaging device 10a is an image sensor that has functions of capturing a visible light image and ranging. It is to be noted that the same components as in Embodiment 1 are labeled with the same symbol, and a description thereof is omitted.

Each of a plurality of pixels 21 included in imager 20a is classified into one of a plurality of types of pixels (G pixel 21a, R pixel 21b, B pixel 21c, GL pixel 21e, GR pixel 21f in this embodiment) that receive light with different characteristics. GL pixel 21e and GR pixel 21f are G pixels for ranging. A pair of GL pixel 21e and GR pixel 21f arranged side-by-side is used for calculating the distance to an object captured in the pixels.

As illustrated in FIG. 6, in imager 20a, pixels 21 are disposed in an array in which one G pixel is replaced by GL pixel 21e or GR pixel 21f in a Bayer array. It is to be noted that in this embodiment, GL pixel 21e and GR pixel 21f are disposed to be arranged alternately in every other pixel in the row direction and the column direction. However, without being limited to this, the pixels may be disposed in every other two pixels. Also, the pixels may be disposed on the entire imager with uneven density.

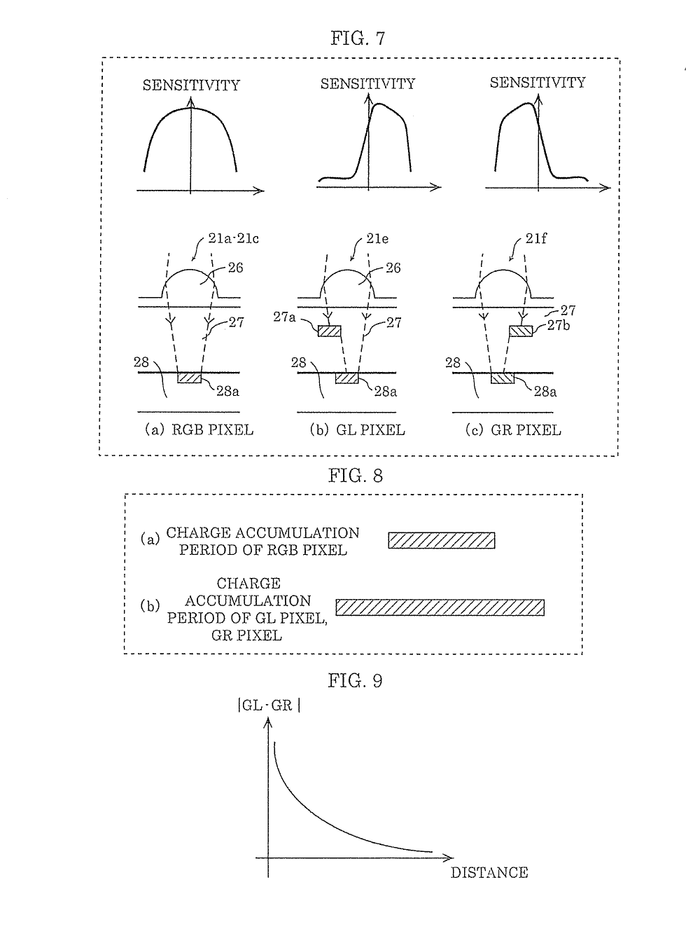

FIG. 7 is a sectional view illustrating the structure of the pixels (G pixel 21a, R pixel 21b, B pixel 21c, GL pixel 21e, GR pixel 21f) included in imager 20a illustrated in FIG. 6 and a diagram illustrating a relationship between the horizontal direction and the sensitivity of the pixels. (a) of FIG. 7 illustrates the sections of G pixel 21a, R pixel 21b and B pixel 21c, (b) of FIG. 7 illustrates the sections of GL pixel 21e, and (c) of FIG. 7 illustrates the section of GR pixel 21f. It is to be noted that in FIG. 7, the color filter of each pixel is omitted.

As illustrated in (a) of FIG. 7, in G pixel 21a, R pixel 21b and B pixel 21c, PD 28a is formed so as to be embedded in substrate 28 such as a silicon substrate, insulation layer 27 is formed so as to cover PD 28a and substrate 28, and a color filter (not illustrated) and micro lens 26 are formed on insulation layer 27.

Also, as illustrated in (b) of FIG. 7, in GL pixel 21e, in addition to the components of G pixel 21a, R pixel 21b, and B pixel 21c illustrated in (a) of FIG. 7, light blocker 27a is formed, that blocks the light that enters in the left direction.

Also, as illustrated in (c) of FIG. 7, in GR pixel 21f, in addition to the components of G pixel 21a, R pixel 21b, and B pixel 21c illustrated in (a) of FIG. 7, light blocker 27b is formed, that blocks the light that enters in the right direction.

In this embodiment, G pixel 21a, R pixel 21b and B pixel 21c correspond to the first type of pixels that receive light in the first direction. Here, the light in the first direction indicates the light that is incident on all of light receiving areas included in the first type of pixels. Specifically, the first type of pixels are pixels (G pixel 21a, R pixel 21b and B pixel 21c) that receive light incident on all of the light receiving areas, in short, light having a high intensity. On the other hand, GL pixel 21e and GR pixel 21f correspond to the second type of pixels that receive light in the second direction different from the first direction. Here, the light in the second direction indicates the light that is incident on part of the light receiving areas included in the second type of pixels. Specifically, the second type of pixels are pixels (GL pixel 21e and GR pixel 21f) that receive light incident on part of the light receiving areas, in short, light having a low intensity due to light blockers 27a and 27b.

Row selection circuit 25a is a circuit that controls the charge accumulation period in imager 20a and that selects pixels 21 from a plurality of pixels 21 included in imager 20a on a row-by-row basis. In the same manner as in Embodiment 1, for the pixels disposed in the same row of imager 20, as control of the charge accumulation period in imager 20a, row selection circuit 25a controls the charge accumulation period by an electronic shutter so that the charge accumulation period for the first type out of the plurality of types of pixels is the first charge accumulation period, and the charge accumulation period for the second type different from the first type out of the plurality of types of pixels is the second charge accumulation period different from the first charge accumulation period. However, in this embodiment, the first type of pixels are pixels (G pixel 21a, R pixel 21b, B pixel 21c) that receive light in the first direction, and the second type of pixels are pixels (GL pixel 21e and GR pixel 21f) that receive light in the second direction. Thus, in this embodiment, row selection circuit 25a controls the charge accumulation period so that the first charge accumulation period and the second charge accumulation period have different lengths.

Specifically, as illustrated in FIG. 8, row selection circuit 25a controls the charge accumulation period so that the charge accumulation period for the second type of pixels (GL pixel 21e and GR pixel 21f) that receive light having a low intensity is longer than the charge accumulation period for the first type of pixels (G pixel 21a, R pixel 21b, B pixel 21c) that receive light having a high intensity. Therefore, in the second type of pixels (GL pixel 21e and GR pixel 21f) that receive light having a low intensity due to light blockers 27a and 27b, deterioration of the accuracy (here, accuracy of ranging) of signal processing due to shortage of light quantity is reduced.

It is to be noted that ranging using a pair of GL pixel 21e and GR pixel 21f arranged side-by-side on the right and left is performed by calculation using the digital values outputted from solid-state imaging device 10a based on the utilization of the following principle (phase difference).

That is, as seen from the sectional view illustrated in FIG. 7, the intensities of incident light in two different directions are identified by GL pixel 21e and GR pixel 21f. The light from an object becomes closer to parallel light as the object is more away, and the quantity of incident light on PD 28a of GL pixel 21e and GR pixel 21f increases without being blocked by light blockers 27a and 27b. Therefore, the difference (difference between image signals on the right and left) between the intensities of incident light on GL pixel 21e and GR pixel 21f approaches zero as the object is more away.

FIG. 9 is a graph illustrating a relationship between the difference (difference between image signals on the right and left) of intensities of incident light on GL pixel 21e and GR pixel 21f and the distance to an object. The distance to an object can be calculated utilizing the relationship illustrated in FIG. 9 based on the difference between the quantities of light of GL pixel 21e and GR pixel 21f. Specifically, the phase difference between image signals on the right and left is detected, which are emitted from the same object, separated into the right and left directions and obtained, then predetermined calculation is applied to the detected phase difference, and thus the distance to the object is calculated.

As described above, with solid-state imaging device 10a in this embodiment, an independent charge accumulation period can be provided according to the type of each of light sources with different directions for receiving light. That is, the charge accumulation period for the second type of pixels (GL pixel 21e and GR pixel 21f) that receive light having a low intensity is set to be longer than the charge accumulation period for the first type of pixels (G pixel 21a, R pixel 21b, B pixel 21c) that receive light having a high intensity. Therefore, in the second type of pixels (GL pixel 21e and GR pixel 21f) that receive light having a low intensity due to light blockers 27a and 27b, deterioration of the accuracy (here, accuracy of ranging) of signal processing due to shortage of light quantity is reduced.

In this embodiment, a pair of pixels for ranging (GL pixel 21e and GR pixel 21f) is disposed apart on the right and left. However, the pair of pixels may be disposed apart vertically. This is because the distance can be measured by the same principle as described above.

In this manner, solid-state imaging device 10a in this embodiment includes: imager 20a that includes a plurality of pixels 21 which are disposed in rows and columns and each of which holds a signal corresponding to a charge accumulated according to an amount of light received in a charge accumulation period; row selection circuit 25a that controls the charge accumulation period and that selects pixels 21 from the plurality of pixels 21 on a row-by-row basis; and read circuit 30 that reads and outputs signals held in pixels 21 from pixels 21 selected by row selection circuit 25a. Each of the plurality of pixels 21 included in imager 20a is classified into one of a plurality of types of pixels that receive light with different characteristics, and for the pixels disposed in the same row of imager 20a, row selection circuit 25a controls the charge accumulation period so that a charge accumulation period for the first type out of the plurality of types of pixels is a first charge accumulation period, and a charge accumulation period for the second type different from the first type out of the plurality of types of pixels is a second charge accumulation period different from the first charge accumulation period.

Here, the first type of pixels 21 are pixels that receive light in the first direction, and the second type of pixels 21 are pixels that receive light in the second direction different from the first direction. Thus, an independent charge accumulation period can be provided according to the type of each of light sources with different directions for receiving light, and a charge accumulation period is provided with an optimal timing or length according to the type of each pixel, and thus deterioration of the accuracy (accuracy of ranging using signals by light in two directions) of signal processing is reduced.

More specifically, the light in the first direction is light that is incident on all of light receiving areas included in the first type of pixels 21, and the light in the second direction is light that is incident on part of light receiving areas included in the second type of pixels 21. Accordingly, the first charge accumulation period and the second charge accumulation period have different lengths of period. Thus, in each pixel, charge is accumulated only during a period having a length according to the intensity of light incident on the pixel. For instance, the charge accumulation period for the second type of pixels in which light is incident on part of light receiving areas can be set to be longer than the charge accumulation period for the first type of pixels in which light is incident on all of the light receiving areas. Therefore, in the second type of pixels that receive light having a low intensity, deterioration of the accuracy of signal processing due to shortage of light quantity is reduced.

### Embodiment 3

Next, a camera in Embodiment 3 of the present disclosure will be described.

Solid-state imaging devices 10 and 10a in Embodiments 1 and 2 described above may be used as a video camera, a digital still camera, or an imaging device (image input device) included in an imager of a camera module for a mobile device such as a mobile phone.

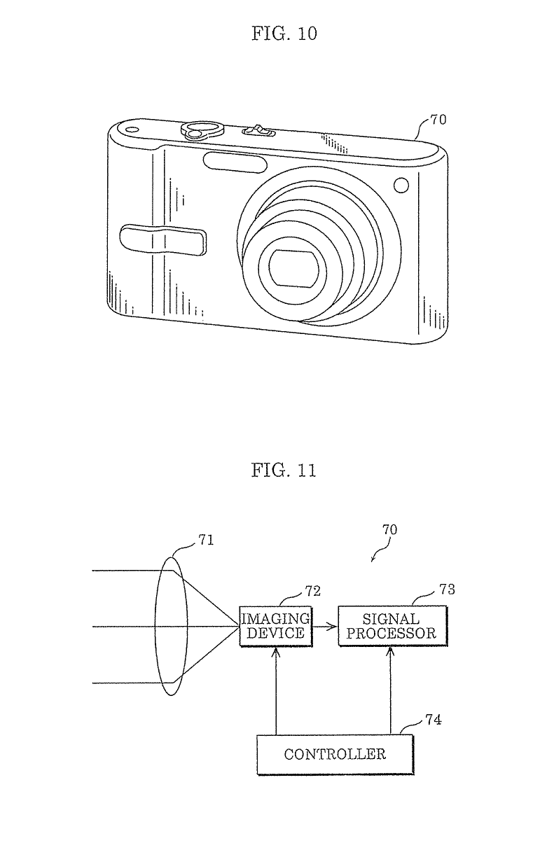

FIG. 10 is an external view of camera 70 in Embodiment 3 of the present disclosure. FIG. 11 is a block diagram illustrating an example of the configuration of camera 70 in Embodiment 3 of the present disclosure. In addition to imaging device 72, as an optical system for guiding incident light to an imager of imaging device 72, camera 70 has lens 71 that causes, for instance, incident light (image light) to form an image on a captured-image surface. In addition, camera 70 includes controller 74 that drives imaging device 72, and signal processor 73 that processes an output signal of imaging device 72.

Imager device 72 outputs an image signal obtained by converting image light formed by lens 71 on a captured-image surface to an electrical signal by pixel unit. As imaging device 72, solid-state imaging device 10 or 10a in Embodiment 1 or 2 is used.

Signal processor 73 is a digital signal processor (DSP) or the like that performs various signal processing including white balance, calculation for ranging on an image signal outputted from imaging device 72. Controller 74 is a system processor or the like that controls imaging device 72 and signal processor 73.

The image signal processed by signal processor 73 is recorded, for example on a recording medium such as a memory. Image information recorded on the recording medium is hard-copied by a printer or the like. Also, the image signal processed by signal processor 73 is displayed as a video on a monitor such as a liquid crystal display.

As described above, the above-described solid-state imaging device 10 or 10a is mounted on an imaging device such as a digital still camera, as imaging device 72, thereby achieving a camera with high accuracy (such as image quality, accuracy of ranging, or analysis accuracy) of signal processing.

Although the solid-state imaging device and camera according to an aspect of the present disclosure have been described so far based on Embodiments 1 to 3, the present disclosure is not limited to these embodiments. As long as not departing from the spirit of the present disclosure, the embodiments on which various modifications, which occur to those skilled in the art, are made, and another embodiment achieved by combining any components in the embodiments may also be included in the scope of the present disclosure.

For instance, in imager 20 in Embodiment 1, IR pixel 21d is disposed in every other pixel in the row direction and the column direction of imager 20. However, IR pixel 21d may be disposed in every two other pixels. The configuration of arrangement of IR pixels may be determined as needed in consideration of called for resolution of IR images.

Furthermore, two or more types of pixels selected arbitrarily from RGB pixel, IR pixel, UV pixel, and pixels for ranging (GL pixel and GR pixel) may be disposed on one imager. For instance, RGB pixel, IR pixel, UV pixel, and pixels for ranging (GL pixel and GR pixel) may be disposed on the imager. Thus, a high-performance solid-state imaging device is achieved capable of performing photography (or analysis) by ultraviolet, visible, infrared light and ranging at the same time. In this case, for the charge accumulation period, three or more types of charge accumulation periods may be provided.

Although the imager has a horizontal two-pixel one-cell structure in the embodiments, without being limited to this, the imager may have one-pixel one-cell structure in which one amplification transistor is provided for each light receiving element, vertical two-pixel one-cell structure in which one amplification transistor is provided for every two light receiving elements arranged in the column direction, or four-pixel one-cell structure in which one amplification transistor is provided for every four light receiving elements adjacent in the column direction and row direction.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure can be utilized as a solid-state imaging device and a camera applicable to a video camera, a digital still camera particularly having high accuracy of signal processing, and further, a camera for a mobile device such as a mobile phone.

What is claimed is:

1. A solid-state imaging device comprising:
an imager that includes a plurality of pixels which are disposed in rows and columns and each of which holds a signal corresponding to a charge accumulated according to an amount of light received in a charge accumulation period;
a row selection circuit that controls the charge accumulation period and selects pixels from the plurality of pixels on a row-by-row basis; and
a read circuit that reads and outputs signals held in the pixels selected by the row selection circuit,
wherein each of the plurality of pixels included in the imager is classified into one of a plurality of types of pixels that receive light with different characteristics, and
for pixels disposed in a same row of the imager, the row selection circuit controls the charge accumulation period so that a charge accumulation period for a first type out of the plurality of types of pixels is a first charge accumulation period, and a charge accumulation period for a second type different from the first type out of the plurality of types of pixels is a second charge accumulation period different from the first charge accumulation period.

2. The solid-state imaging device according to claim 1,
wherein after reading the signals from all of the first type of pixels included in the imager, the read circuit reads the signals from all of the second type of pixels included in the imager.

3. The solid-state imaging device according to claim 1,
wherein the read circuit amplifies the signals read from the first type of pixels by a first magnification, and
amplifies the signals read from the second type of pixels by a second magnification different from the first magnification.

4. The solid-state imaging device according to claim 2,
wherein the read circuit amplifies the signals read from the first type of pixels by a first magnification, and
amplifies the signals read from the second type of pixels by a second magnification different from the first magnification.

5. The solid-state imaging device according to claim 4,
wherein the read circuit reads the signals held in the pixels selected by the row selection circuit, via a column signal line, and
the first type of pixels and the second type of pixels share a circuit that outputs the signals held in the first type of pixels and the second type of pixels to the column signal line.

6. The solid-state imaging device according to claim 4,
wherein the first type of pixels are pixels that receive light in a first wavelength range, and the second type of pixels are pixels that receive light in a second wavelength range different from the first wavelength range.

7. The solid-state imaging device according to claim 6,
wherein the first wavelength range is a wavelength range of visible light, and
the second wavelength range is a wavelength range of infrared light or ultraviolet light.

8. The solid-state imaging device according to claim 4,
wherein the first type of pixels are pixels that have a first optical input structure, and
the second type of pixels are pixels that have a second optical input structure different from the first optical input structure.

9. The solid-state imaging device according to claim 4,
wherein the first type of pixels are pixels that have a first optical input structure,
the second type of pixels are pixels that have a second optical input structure different from the first optical input structure, and
at least one of the first optical input structure and the second optical input structure includes a light blocker.

10. The solid-state imaging device according to claim 8,
wherein the first type of pixels are pixels that receive light in a first direction, and
the second type of pixels are pixels that receive light in a second direction different from the first direction.

11. The solid-state imaging device according to claim 10,
wherein the light in the first direction is light that is incident on all of light receiving areas included in the first type of pixels, and
the light in the second direction is light that is incident on part of the light receiving areas included in the second type of pixels.

12. The solid-state imaging device according to claim 4,
wherein the first charge accumulation period and the second charge accumulation period are different in length.

13. The solid-state imaging device according to claim 4,
wherein the first charge accumulation period and the second charge accumulation period are partially overlapped.

14. A camera comprising the solid-state imaging device according to claim 1.
